(19) United States
(12) Patent Application Publication
(10) Pub. No.: US 2025/0335750 A1
(43) Pub. Date: Oct. 30, 2025

(54) SYSTEMS AND METHODS FOR USING A GENERATIVE MODEL TO GENERATE AN OUTPUT BASED ON A SET OF DIVERSE INPUTS

(71) Applicant: TOYOTA RESEARCH INSTITUTE, INC., Los Altos, CA (US)

(72) Inventors: Francine R. CHEN, Menlo Park, CA (US); Tatiana LAU, San Francisco, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/651,418

(22) Filed: Apr. 30, 2024

(51) Int. Cl. G06N 3/0475

(52) U.S. Cl. CPC G06N 3/0475

(57) ABSTRACT

A method for compromising between competing ideas includes generating a group of embedded inputs by embedding each input of a group of inputs in an embedding space. The method also includes weighting each embedded input of the group of embedded inputs based on one or more parameters. The method further includes calculating a weighted centroid based on weighting each embedded input. The method still also includes generating, via a generative model, an output based on the weighted centroid.

### BACKGROUND

### Field

Aspects of the present disclosure generally relate to generative models, and more specifically to systems and methods for using a generative model to generate an output based on diverse inputs.

### Background

Generative models, such as generative artificial intelligence (AI) models, exemplify the capabilities of neural network models trained on extensive datasets of pre-existing content (hereinafter referred to as training data). Based on this training, generative models may discern intricate patterns and establish meaningful connections within the training data and/or input data. When provided with a prompt, a generative model may generate an output in one or more forms, such as, but not limited to, text, images, and/or music, in accordance with the training data and/or the previous input data.

In the context of generative models, embedding refers to transforming categorical or discrete data, such as words or categorical variables, into continuous vector representations within a multi-dimensional space. This transformation enables the generative model to capture meaningful relationships and similarities in the data. For example, in natural language processing, word embeddings map words to vectors, preserving semantic relationships, such that a generative model may understand the context and similarities between words. Based on the embedding process, the generative model may generalize and make predictions based on the underlying patterns in the data, contributing to improved performance in various machine learning tasks.

### SUMMARY

In one aspect of the present disclosure, a method for compromising between competing ideas includes generating a group of embedded inputs by embedding each input of a group of inputs in an embedding space. The method also includes weighting each embedded input of the group of embedded inputs based on one or more parameters. The method further includes calculating a weighted centroid based on weighting each embedded input. The method still also includes generating, via a generative model, an output based on the weighted centroid.

Another aspect of the present disclosure is directed to an apparatus including means for generating a group of embedded inputs by embedding each input of a group of inputs in an embedding space. The apparatus also includes means for weighting each embedded input of the group of embedded inputs based on one or more parameters. The apparatus further includes means for calculating a weighted centroid based on weighting each embedded input. The apparatus still also includes means for generating, via a generative model, an output based on the weighted centroid.

In another aspect of the present disclosure, a non-transitory computer-readable medium with non-transitory program code recorded thereon is disclosed. The program code is executed by a processor and includes program code to generate a group of embedded inputs by embedding each input of a group of inputs in an embedding space. The program code further includes program code to weight each embedded input of the group of embedded inputs based on one or more parameters. The program code also includes program code to calculate a weighted centroid based on weighting each embedded input. The program code still also generate, via a generative model, an output based on the weighted centroid.

Another aspect of the present disclosure includes an apparatus including a processor, and a memory coupled with the processor and storing instructions operable, when executed by the processor, to cause the apparatus to generate a group of embedded inputs by embedding each input of a group of inputs in an embedding space. Execution of the instructions also cause the apparatus to weight each embedded input of the group of embedded inputs based on one or more parameters. Execution of the instructions further cause the apparatus to calculate a weighted centroid based on weighting each embedded input. Execution of the instructions still also cause the apparatus to generate, via a generative model, an output based on the weighted centroid.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram illustrating an example of a system generating content via a generative model, in accordance with aspects of the present disclosure.

FIG. 2 is a diagram illustrating an example of a hardware implementation for a system, in accordance with aspects of the present disclosure.

FIG. 3 is a diagram illustrating an example of a pipeline associated with a process for determining a solution for competing inputs, in accordance with aspects of the present disclosure.

FIG. 4 illustrates a proposal embedding space, in accordance with aspects of the present disclosure.

FIG. 5 is a diagram illustrating an example of a pipeline associated with a process for determining a solution for competing inputs, in accordance with aspects of the present disclosure.

FIG. 6 illustrates a weighted centroid in a proposal embedding space, in accordance with aspects of the present disclosure.

FIG. 7 is a flow diagram illustrating an example process for compromising between competing ideas, in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

In some situations, a group of users may want to determine a common output based on a group of user inputs. For example, multiple users may each propose a different solution to a problem. A few methods exist to determine an output based on each of the inputs. One method involves the users voting to decide what the output should be. In another method, the users may compromise to determine the output. The users could also implement an arbitrator or some other third-party to decide the output based on the group of inputs. For instance, the users may attempt to use generative AI to generate a common output based on the inputs.

However, these methods are flawed in several respects. First, the methods are each subject to some form of bias. For example, outputs based on compromise may be biased towards users with better negotiation skills. Even a generative model may exhibit bias depending on how the model is trained. The generative model may additionally lack the problem-solving capabilities to determine the output. For instance, the generative model may provide an output that is based on only a small fraction of the inputs. Sometimes, the generative model may produce an output that is a mere regurgitation of seemingly random portions of the user input.

Various aspects of the present disclosure are directed to techniques for generating, via a generative model, an output based on a set of diverse inputs. In some examples, a neural network model receives a group of diverse inputs from a group of users. The neural network model may have an encoder-decoder architecture. In some examples, the neural network model is a generative model. The neural network model may generate an embedding for each input of the group of inputs and determine a centroid of a resulting embedding space, where each embedding may be a numerical representation of a respective input. Each embedding may be weighed based on one or more parameters, such as, but not limited to, a distance from the centroid and/or one or more factor values. The factor values may represent an input's applicability to a factor, such as cost, equity, diversity, or sustainability.

After weighting the embeddings, the generative model generates a weighted centroid based on the centroid and the weighted embeddings. Depending on the weights of the embeddings, the weighted centroid may not be in the center of the embeddings of the embedding space. Instead, each weighted embedding may have a different effect on the weighted centroid. After the device generates the weighted centroid, the device decodes the weighted centroid to produce an output.

Particular aspects of the subject matter described in this disclosure can be implemented to realize one or more of the following potential advantages. In some examples, the described techniques include generating a novel output based on a group of inputs and their respective embedding's proximity to the centroid of an embedding space and/or factor values. This technique enables generative models to better prevent bias and contextualize input data. Other advantages of the described techniques include improved generative model problem-solving capabilities and a way to generate a novel output that incorporates multiple user inputs.

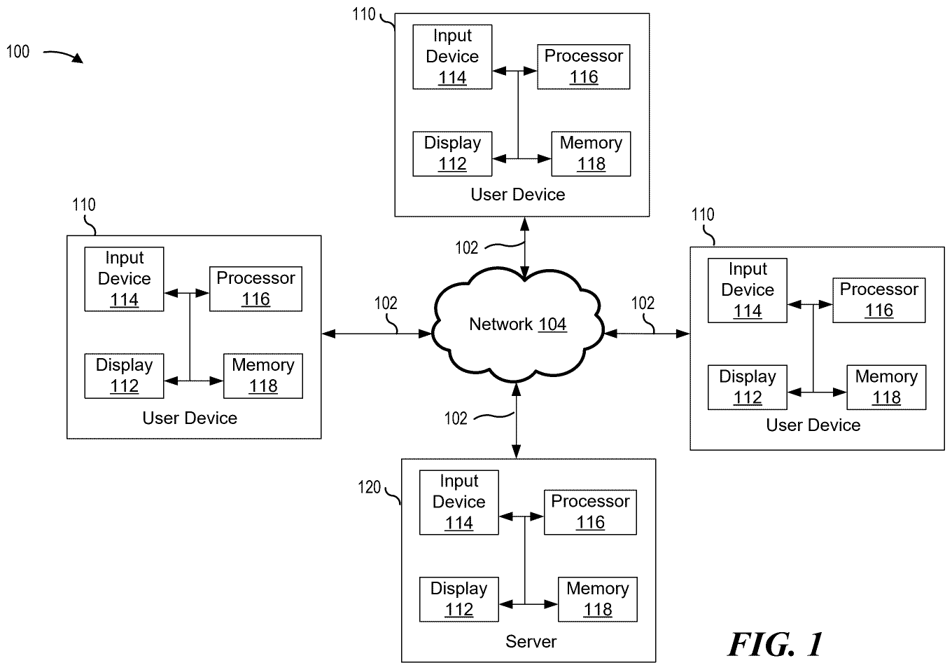

FIG. 1 is a block diagram illustrating an example of a system 100 generating content via a generative model, in accordance with aspects of the present disclosure. As shown in the example of FIG. 1, the system 100 may include one or more user devices 110 and one or more servers 120. For ease of explanation, only one server 120 is shown in the example of FIG. 1. Each user device 110 may be connected to a network 104 via one or more communication links 102. The communication links 102 may be wired and/or wireless communication links. The server 120 may also be connected to the network 104 via a communication link 102.

The network 104 may be an example of the Internet. Additionally, or alternatively, the network 104 may include any suitable computer network such as an intranet, a wide-area network (WAN), a local-area network (LAN), a wireless network, a digital subscriber line (DSL) network, a frame relay network, an asynchronous transfer mode (ATM) network, and/or a virtual private network (VPN). The communication links 102 may be any type of communication link that may be suitable for communicating data between user devices 110 and the server 120. For example, the communication links 102 may network links, dial-up links, wireless links (e.g., Wi-Fi link, satellite link, or cellular communication link), and/or hard-wired links.

The server 120 may be a computing device, such as a server, processor, computer, cloud computing device, cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to host a generative model and communicate via a wireless or wired medium. In some examples, the server 120 may host a generative model. In some such examples, one or more server 120 may work in tandem to host the generative model. Specifically, the server 120 may implement functions and/or computer code that runs the generative model and/or a site, such as a website, for accessing the generative model.

Each user device 110 may be an example of a personal computing device, a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium. A user device 110 may be used by a user to input a prompt to a generative model via an interface associated with the generative model. The interface may be accessed via a website or a dedicate application, such as a mobile phone application. Additionally, or alternatively, the user device 110 may store the generative model, and the user may input a prompt via an interface associated with the stored generative model. In some examples, each user device 110 shown in FIG. 1 may be used by a different user. Each user device 110 and server 120 may be stationary or mobile.

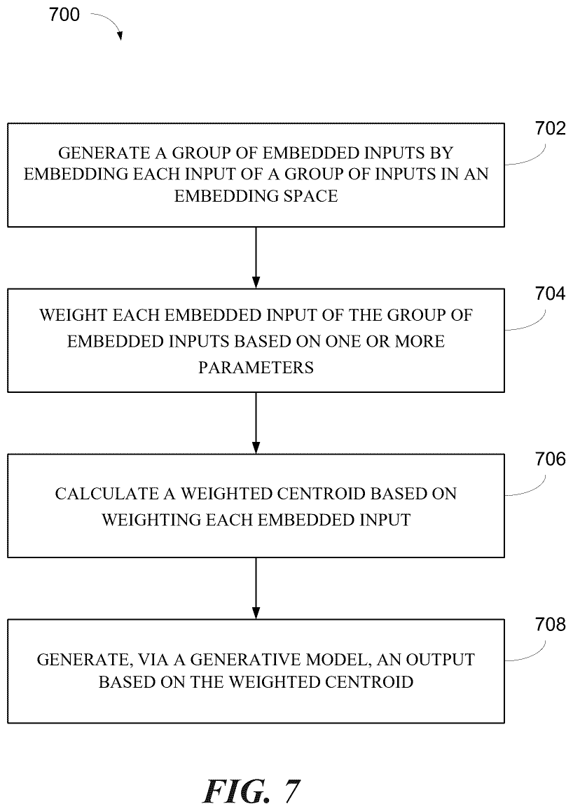

In some examples, each user device 110 may be included inside a housing that houses components of the user device 110, such as one or more processors 116 and a memory 118. The housing may also include, or be connected to, a display 112 and an input device 114, which may be interconnected with other components of the user device 110. For case of explanation, only one processor 116 is shown for each user device 110. In some examples, the one or more processors 116, the display 112, the input device 114, and the memory 118 may be interconnected via a bus architecture. The memory 118 may include one or more different types of memory, such as random access memory (RAM), static RAM (SRAM), dynamic RAM (DRAM), and/or another type of memory. Each user device 110 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the user device 110. The input device 114 may be used to navigate the interface associated with the generative model, provide input to a recommendation module, and/or perform other tasks. Working in conjunction with one or more components of the user device 110, the processor 116 may receive information associated with the generative model, and control the display 112 to output information associated with the generative model. The display 112 may output (e.g., display) information received at the processor 116. In some examples, the processor 116 of the user device 110 is configured to perform operations and implement one or more elements associated with one or more processes, such as the process 700 described with respect to FIG. 7.

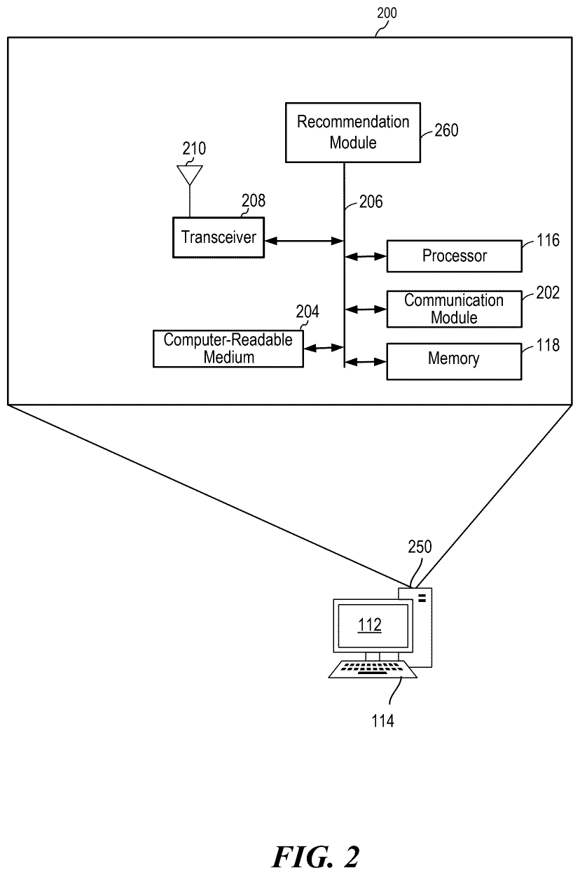

In some examples, a generative AI host may maintain the server 120. The server 120 may be included inside a housing that houses components of the server 120, such as one or more processors 116 and a memory 118. The housing may also include, or be connected to, a display 112 and an input device 114, which may be interconnected with other components of the user device 110. For ease of explanation, only one processor 116 is shown for the server 120. In some examples, the one or more processors 116, the display 112, the input device 114, and the memory 118 may be interconnected via a bus architecture. The memory 118 may include one or more different types of memory, such as RAM, SRAM, DRAM, and/or another type of memory. The server 120 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the server 120. For example, the processor 116 may execute instructions for maintaining the generative model, training the generative model, and/or executing the generative model. In some examples, the processor 116 of the server 120 is configured to perform operations and implement one or more elements associated with one or more processes, such as the process 700 described with respect to FIG. 7. Additionally, or alternatively, the processor 116 of the server 120 may be configured to perform operations associated with the recommendation module 260 described with reference to FIG. 2.

FIG. 2 is a diagram illustrating an example of a hardware implementation for a system 200, according to various aspects of the present disclosure. The system 200 may be a component of a device 250. The device 250 may be an example of a user device 110 or a server 120 described with reference to FIG. 1. As shown in the example of FIG. 2, the device 250 may include a display 112 and an input device 114 (e.g., a keyboard). In some examples, the system 200 is configured to perform operations and implement one or more elements associated with one or more processes, such as the process 700 described with reference to FIG. 7.

The system 200 may be implemented with a bus architecture, represented generally by a bus 206. The bus 206 may include any number of interconnecting buses and bridges depending on the specific application of the system 200 and the overall design constraints. The bus 206 links together various circuits including one or more processors and/or hardware modules, represented by a processor 116, and a communication module 202. The bus 206 may also link various other circuits such as timing sources, peripherals, voltage regulators, and power management circuits, which are well known in the art, and therefore, will not be described any further.

The system 200 includes a transceiver 208 coupled to the processor 116, the communication module 202, and the computer-readable medium 204. The transceiver 208 is coupled to an antenna 210. The transceiver 208 communicates with various other devices over a transmission medium, such as a communication link 102 described with reference to FIG. 1. For example, the transceiver 208 may receive commands via transmissions from a user or a remote device.

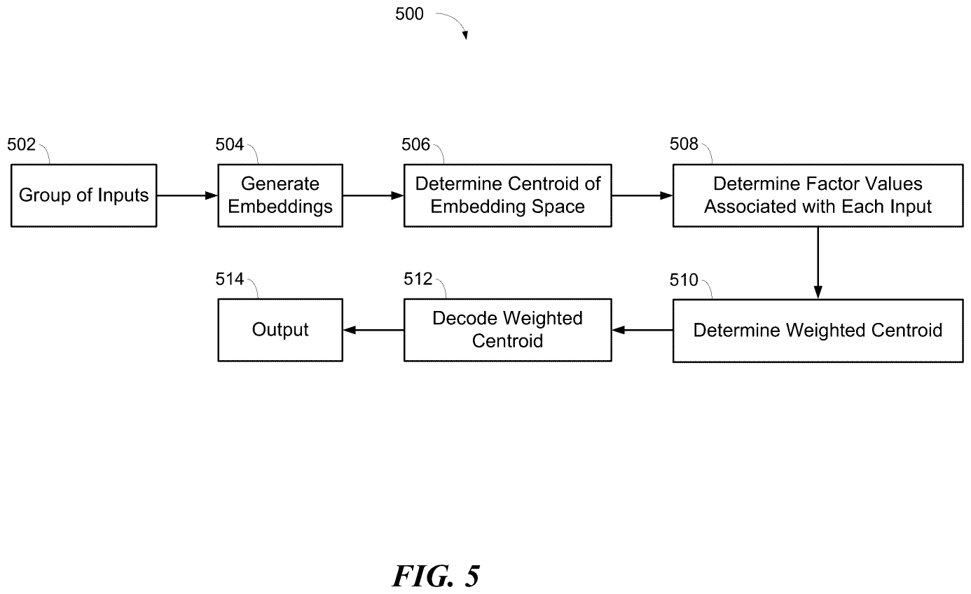

As shown in the example of FIG. 2, the system 200 may include a recommendation module 260 that may be trained to perform one or more tasks associated with generating recommendations based on competing ideas. For example, the recommendation module 260 may be trained to perform the tasks described with reference to the one or more modules or engines described with reference to FIG. 5. The recommendation module 260 may include artificial or computational intelligence elements, such as, neural network, fuzzy logic, or other machine learning algorithms. In one or more arrangements, one or more of the other modules 116, 118, 202, 204, 208, can also include artificial or computational intelligence elements, such as, neural network, fuzzy logic, or other machine learning algorithms. Further, in one or more arrangements, one or more of the modules 116, 118, 202, 204, 208 can be distributed among multiple modules 116, 118, 202, 204, 208, 260 described herein. In one or more arrangements, two or more of the modules 116, 118, 202, 204, 208, 260 of the system 200 can be combined into a single module.

The system 200 includes the processor 116 coupled to the computer-readable medium 204. The processor 116 performs processing, including the execution of software stored on the computer-readable medium 204 providing functionality according to the disclosure. The software, when executed by the processor 116, causes the system 200 to perform the various functions described for a particular device, such as any of the modules 116, 118, 202, 204, 208, 260. For example, when executed by the processor 116, the software causes the system 200 and/or the recommendation module 260 to implement one or more elements associated with one or more processes, such as the process 700 described with respect to FIG. 7. The computer-readable medium 204 may also be used for storing data that is manipulated by the processor 116 when executing the software. For example, working in conjunction with one or more of the other modules the modules 116, 118, 202, 204, and 208, the recommendation module 260 may generate a group of embedded inputs by embedding each input of a group of inputs in an embedding space. The recommendation module 260 may further weight each embedded input of the group of embedded inputs based on one or more parameters. The recommendation module 260 may additionally calculate a weighted centroid based on weighting each embedded input. The recommendation module 260 may still also generate, via a generative model, an output based on the weighted centroid.

As indicated above, FIGS. 1 and 2 are provided as examples. Other examples may differ from what is described with regard to FIGS. 1 and 2.

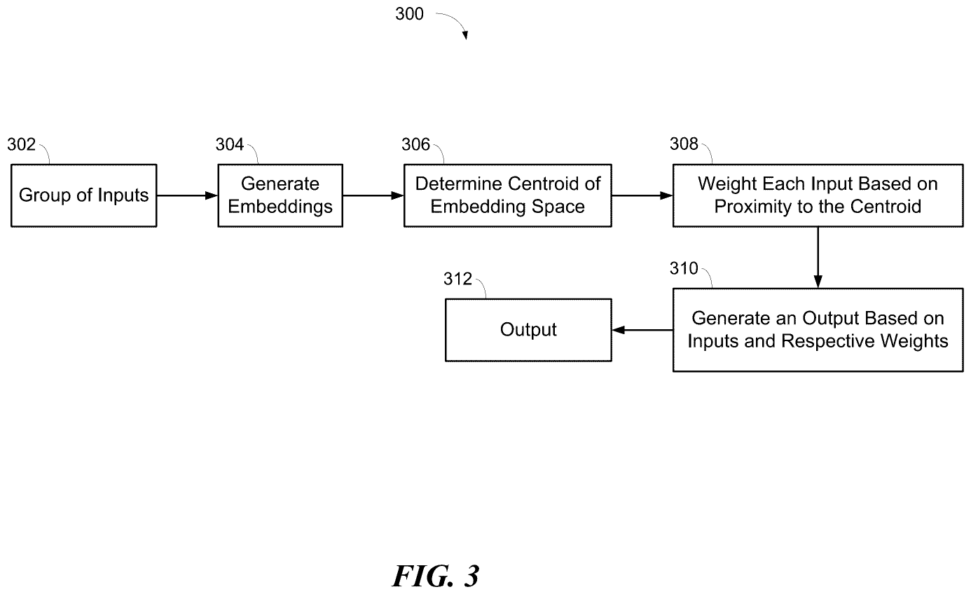

FIG. 3 is a diagram illustrating an example of a pipeline 300 associated with a process for determining a solution for competing inputs, in accordance with aspects of the present disclosure. Various devices and systems may implement the pipeline 300, such as the system 100 described with respect to FIG. 1, or the recommendation module 260 described with respect to FIG. 2.

Initially, the pipeline 300 receives a group of inputs 302. The group of inputs 302 may be a set of diverse inputs. For example, each input may be a different idea, such as a proposed solution to the problem. In some examples, a problem may be presented to a group of users, and each user may contribute their own proposed solution. For instance, the group of users may be asked to design a new building. Each user may then propose their own design concept, including art décor and architectural style. The pipeline 300 then receives these proposals as the group of inputs 302. Aspects of the present disclosure are not limited to each input, of the group of inputs 302, being a proposal to a problem, other types of inputs are contemplated.

The group of inputs 302 may originate from a variety of sources. As explained, a group of users may provide proposals for the group of inputs 302. Additionally, or alternatively, the pipeline 300 may implement a generative model to provide one or more of the inputs of the group of inputs 302. For example, the pipeline 300 may include a generative pre-training transformer (GPT) model to generate one or more inputs of the group of inputs 302. It is also contemplated that the users may each provide more than one input of the group of inputs 302.

After receiving the group of inputs 302, an embedding module 304 generates embeddings based on the inputs. The embeddings may be embedded in an embedding space as numerical vector representations of the group of inputs 302, enabling functions to compute relationships between the different inputs. The embedding module 304 may implement a conventional embedding or dimensionality reduction technique to compute these embeddings, such as principal component analysis (PCA), singular value decomposition (SVD), continuous bag of words (CBOW), skip-gram, or a neural network encoder.

After the embedding module 304 generates embeddings based on the group of inputs 302, a centroid calculation module 306 determines a centroid of the embeddings in the embeddings space. The centroid may represent the central point or average of the inputs in the embedding space. The centroid calculation module 306 may use any conventional process to find the centroid of the embedding space, such as averaging all the embeddings in the space.

Once the centroid is calculated, a weighting module 308 weights the inputs based on their respective embedding's proximity to the centroid. Embeddings closer to the centroid result in a higher weight value compared to embeddings that are farther away from the centroid. Based on weighting each input according to the proximity of the input's embedding to the centroid, a respective weight of inputs closer to a shared central concept (e.g., centroid) of the group of inputs 302 may be greater than the respective weights of inputs farther away from the central concept. Based on the weighting, inputs closer to the shared central concept may have a stronger influence on the final output. Additionally, or alternatively, the weighting module 308 may implement other factors to determine the weight value of the proposals.

As shown in the example of FIG. 3, the pipeline 300 also includes an output module 310. The output module 310 generates an output 312 based on the weight values and respective inputs such that the inputs associated with larger weight values have a greater influence on the output 312 than the proposals associated with smaller weight values. In some examples, the output module 310 may implement a generative model to create the output 312. The generative model may be a conventional generative model, such as ChatGPT™, or a proprietary generative model. For example, the generative model may be based on a variational autoencoder (VAE) or a transformer-based text generation model, such as, but not limited to, GPT-4, T5, Claude™, or Large Language Model Meta AI™ (LLaMA). The output module 310 leverages the collective inputs (e.g., group of inputs 302) and their weights to generate a novel and unique output. By integrating the diverse perspectives and considering the varying influences of each input, the output module 310 generates an output that captures an essence of a shared concept while incorporating the creativity and contributions of the users. As an example, the output 312 may be a new solution based on the group of inputs 302.

Although the pipeline 300 illustrated with respect to FIG. 3 demonstrates a technique for generating an output 312 based on a group of inputs 302, FIG. 3 only exemplifies various aspects of the present disclosure. Various aspects of the present disclosure are directed to various techniques for receiving multiple inputs from a group of users, embedding the inputs in an embedding space, weighting the inputs based on a respective proximity to the centroid of the embedding space, and generating a novel output based on the weighted inputs.

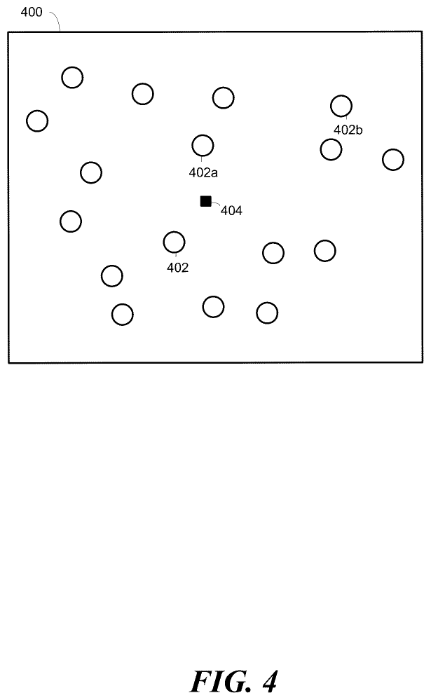

FIG. 4 illustrates a proposal embedding space, in accordance with aspects of the present disclosure. As shown in the example of FIG. 4, the embedding space 400 includes a group of embeddings 402 and a centroid 404. For simplicity, only some of the embeddings 402 are labeled. Each embedding 402 may be a numerical vector representation of the group of inputs 302. The centroid 404 represents the center of the group of embeddings 402 in the embedding space 400. Various aspects of the present disclosure may include weighting an input based on the proximity of the input's embedding 402 to the centroid 404, such that a first embedding 402a that is closer to the centroid 404 has a greater weight in comparison to a weight assigned to a second embedding 402b that is farther from the centroid 404.

The embedding space 400 illustrates an example of an embedding space. In practice, various aspects of the present disclosure may implement embedding spaces of different dimensions and sizes.

FIG. 5 is a flow diagram illustrating an example of a pipeline 500 associated with a process for determining a solution for competing inputs, in accordance with aspects of the present disclosure. Various devices and systems may implement the pipeline 500, such as the system 100 described with respect to FIG. 1, or the recommendation module 260 described with respect to FIG. 2.

Initially, the pipeline 500 receives a group of inputs 502. The group of inputs 502 may be a set of diverse inputs. For example, each input may be a different idea, such as a proposed solution to the problem. In some examples, a problem may be presented to a group of users, and each user may contribute their own proposed solution. For instance, the group of users may be asked to design a new building. Each user may then propose their own design concept, including art décor and architectural style. The pipeline 500 then receives these proposals as the group of inputs 502. Aspects of the present disclosure are not limited to each input, of the group of inputs 502, being a proposal to a problem, other types of inputs are contemplated.

The group of inputs 502 may originate from a variety of sources. As explained, a group of users may provide proposals for the group of inputs 502. Additionally, or alternatively, the pipeline 500 may implement a generative model to provide one or more of the inputs of the group of inputs 502. For example, the pipeline 500 may include a generative model to generate one or more inputs of the group of inputs 502. It is also contemplated that the users may each provide more than one input of the group of inputs 502.

After receiving the group of inputs 502, an embedding module 504 generates embeddings based on the inputs. The embeddings may be embedded in an embedding space as numerical vector representations of the group of inputs 502, enabling functions to compute relationships between the different inputs. The embedding module 504 may implement a conventional embedding or dimensionality reduction technique to compute these embeddings, such as principal component analysis (PCA), singular value decomposition (SVD), continuous bag of words (CBOW), skip-gram, or a neural network encoder.

After the embedding module 504 generates embeddings based on the group of inputs 502, a centroid calculation module 506 determines a centroid of the embeddings in the embeddings space. The centroid may represent the central point or average of the inputs in the embedding space. The centroid calculation module 506 may use any conventional process to find the centroid of the embedding space, such as averaging all the embeddings in the space.

The pipeline 500 may additionally include a factor module 508. The factor module 508 determines, for each input of the group of inputs 502, one or more factor values, where each factor value is based on the respective input's applicability to a factor. Potential factors include, but are not limited to, cost, equity, diversity, sustainability, feasibility, impact, scalability, risk, or innovation. The factor may be provided as input to the pipeline 500. In some examples, the factor values may be concatenated to the one or more inputs of the group of inputs 502. For example, if the pipeline 500 implements a neural network model, a delimiter preceding each input factor in the combined input array may be used to indicate each factor. Additionally, or alternatively, the factors may be predicted for each input using machine learning before the combined array is created, and then used as input.

In one example, a group of users are asked to submit proposed solutions to a problem. Each user, of the group of users, submits a proposed solution, and each proposed solution is provided as input to the pipeline 500. In such examples, the factor module 508 may then evaluate an applicability of each proposed solution to one or more factors. For instance, the factor module 508 may evaluate a respective cost associated with implementing each proposed solution and assign a respective cost factor value to each proposed solution. For example, an implementation cost may be inversely related to a cost factor value (e.g., a higher cost is associated with a lower cost factor value), or vice versa. The factor module 508 may also evaluate each proposed solution based on diversity, where the proposed solution receives a diversity factor value in accordance with an ability of the proposed solution to promote diversity (e.g., racial diversity). A weight of an embedding may be based on one or more factor values. For example, the weight of an embedding may be increased based on the embedding having a higher cost factor value and the embedding having a higher diversity factor value.

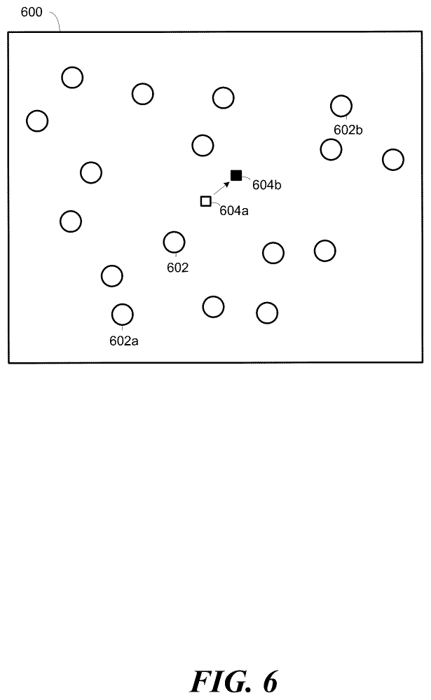

The factor module 508 may implement one or more techniques to evaluate the group of inputs 502 based on one or more factors. Based on the evaluation, the factor module 508 may assign one or more factor values for each input of the group of inputs 502. Additionally, or alternatively, the factor module 508 may weigh each embedding based on a respective distance from an initial centroid determined via the centroid calculation module 506 and/or the one or more respective factor values. In some examples, a weighted centroid module 510 generates a weighted centroid based on the weight of each embedding of the group of inputs 502. A position of the weighted centroid may be influenced by the weight of embeddings. For example, embeddings associated with respective inputs having a higher factor value may have more of an influence on the position of the weighted centroid in comparison to embeddings associated with respective inputs having a lower factor value. The weighted centroid may have a different numerical vector representation than an initial centroid calculated by the centroid calculation module 506. Generating the weighted centroid is further discussed and illustrated with respect to FIG. 6.

After the weighted centroid module 510 generates the weighted centroid, a decoder 512 produces an output 514 by decoding the weighted centroid. For example, the decoder 512 may translate the numerical vector representation associated with the weighted centroid into a human-interpretable form, such as words or sentences. The pipeline 500 may then provide the output 514 to one or more users.

In some examples, the embedding may be weighted based only on one or more factor values. That is, a distance from an initial centroid may not be used for a respective weight of each embedding. In such examples, a centroid calculation module 506 may be bypassed and an initial centroid is not determined.

FIG. 6 is a diagram illustrating an example of a weighted centroid in an embedding space, in accordance with aspects of the present disclosure. As illustrated in FIG. 6, the embedding space 600 includes a group of embeddings 602, a first centroid 604a, and a weighted centroid 604b. For simplicity, only some of the embeddings 602 are labeled. As discussed with respect to FIG. 5, each embedding 602 may be a numerical vector representation of an input of a group of inputs 502.

In some examples, each embedding 602 is not weighted. In such examples, the first centroid 604a represents a center of the group of embeddings 602 in the embedding space 600. Specifically, the first centroid 604a is a point in the embedding space 600 that represents the average (e.g., central point) of a group of vectors associated with the group of embeddings 602. An element-wise average of the group of vectors may be used to determine the first centroid 604a. The first centroid may capture the collective characteristics or the central tendency of the group of embeddings 602.

In some other examples, each embedding 602 may be weighted. For example, each embedding may be weighted based on a distance from the first centroid 604a and/or one or more factor values. In such examples, a weight may be assigned to the respective vector (e.g., embedding vector) of each embedding 602. The weight may reflect an importance of each embedding. Higher weights may have a greater influence on a final centroid (e.g., weighted centroid 604b). In contrast to the unweighted example, each embedding vector may be multiplied by a corresponding weight. The weighted vectors may be summed and then divided by the sum of all of the weights to determine the weighted centroid 604b. In some examples, the weighted centroid module 510 described with reference to FIG. 5 may generate the weighted centroid 604b.

In the example illustrated with respect to FIG. 6, both the first centroid 604a and the weighted centroid 604b represent a numerical vector representation in the embedding space 600. For the weighted centroid 604b, the numerical vector representation may be biased toward embeddings 602 with higher weights. For example, a first embedding 602b may be weighted more than the other embeddings 602, and a second embedding 602a may be weighted less than the other embeddings 602. In this example, the position of the weighted centroid 604b in the embedding space 600 may be close to the first embedding 602b.

FIG. 7 is a flow diagram illustrating an example process for compromising between competing ideas, in accordance with aspects of the present disclosure. One or devices may implement the process 700, such as the recommendation module 260 illustrated with respect to FIG. 2. At block 702, the process 700 generates a group of embedded inputs by embedding each input of a group of inputs in an embedding space. At block 704, the process 700 weights each embedded input of the group of embedded inputs based on one or more parameters. At block 706, the process 700 calculates a weighted centroid based on weighting each embedded input. At block 708, the process 700 generates, via a generative model, an output based on the weighted centroid.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine-readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for compromising between competing ideas, comprising:
generating a group of embedded inputs by embedding each input of a group of inputs in an embedding space;
weighting each embedded input of the group of embedded inputs based on one or more parameters;
calculating a weighted centroid based on weighting each embedded input; and
generating, via a generative model, an output based on the weighted centroid.

2. The method of claim 1, wherein each input of the group of inputs is a solution to a problem.

3. The method of claim 2, wherein the output is a novel solution to the problem.

4. The method of claim 1, wherein the one or more parameters include a distance from an initial centroid and/or one or more factor values.

5. The method of claim 4 wherein:
each factor value of the one or more factor values is associated with a different factor of a group of factors; and
the group of factors include at least one of cost, equity, diversity, or sustainability.

6. The method of claim 4, wherein the initial centroid is based on the group of embedded inputs, prior to weighting each embedded input.

7. The method of claim 1, wherein the output is different than each input of the group of inputs.

8. An apparatus for compromising between competing ideas, comprising:
one or more processors; and
one or more memories coupled with the one or more processors and storing instructions operable, when executed by the one or more processors, to cause the apparatus to:
generate a group of embedded inputs by embedding each input of a group of inputs in an embedding space;
weight each embedded input of the group of embedded inputs based on one or more parameters;
calculate a weighted centroid based on weighting each embedded input; and
generate, via a generative model, an output based on the weighted centroid.

9. The apparatus of claim 8, wherein each input of the group of inputs is a solution to a problem.

10. The apparatus of claim 9, wherein the output is a novel solution to the problem.

11. The apparatus of claim 8, wherein the one or more parameters include a distance from an initial centroid and/or one or more factor values.

12. The apparatus of claim 11 wherein:
each factor value of the one or more factor values is associated with a different factor of a group of factors; and
the group of factors include at least one of cost, equity, diversity, or sustainability.

13. The apparatus of claim 11, wherein the initial centroid is based on the group of embedded inputs, prior to weighting each embedded input.

14. The apparatus of claim 8, wherein the output is different than each input of the group of inputs.

15. A non-transitory computer-readable medium having program code recorded thereon for compromising between competing ideas, the program code executed by a processor and comprising:
program code to generate a group of embedded inputs by embedding each input of a group of inputs in an embedding space;
program code to weight each embedded input of the group of embedded inputs based on one or more parameters;
program code to calculate a weighted centroid based on weighting each embedded input; and
program code to generate, via a generative model, an output based on the weighted centroid.

16. The non-transitory computer-readable medium of claim 15, wherein:
each input of the group of inputs is a solution to a problem; and
the output is a novel solution to the problem.

17. The non-transitory computer-readable medium of claim 15, wherein the one or more parameters include a distance from an initial centroid and/or one or more factor values.

18. The non-transitory computer-readable medium of claim 17 wherein:
each factor value of the one or more factor values is associated with a different factor of a group of factors; and
the group of factors include at least one of cost, equity, diversity, or sustainability.

19. The non-transitory computer-readable medium of claim 17, wherein the initial centroid is based on the group of embedded inputs, prior to weighting each embedded input.

20. The non-transitory computer-readable medium of claim 15, wherein the output is different than each input of the group of inputs.
